(19) United States
(12) Patent Application Publication
(10) Pub. No.: US 2020/0388184 A1
(43) Pub. Date: Dec. 10, 2020

(54) SYSTEM AND METHOD FOR PROVIDING STATUS INDICATIONS USING MULTIPLE-CHOICE QUESTIONS

(71) Applicant: The Toronto-Dominion Bank, Toronto (CA)

(72) Inventors: Nasim SARIR, Thornhill (CA); Steven GERVAIS, Newmarket (CA)

(73) Assignee: The Toronto-Dominion Bank, Toronto (CA)

(21) Appl. No.: 16/434,819

(22) Filed: Jun. 7, 2019

(51) Int. Cl. G09B 7/077; G09B 19/18; G06Q 40/02; G06Q 30/02

(52) U.S. Cl. CPC G09B 7/077; G06Q 30/0215; G06Q 40/02; G09B 19/18

(57) ABSTRACT

A computer-implemented method and related systems are disclosed. The method includes receiving records related to transfers for accounts. The transfers correspond to categories. A net outflow from the accounts for a period for a particular category is identified based on the transfers corresponding to the particular category. If it is determined that an amount of the net outflow exceeds an expected outflow for the period for the particular category, a multiple-choice quiz question and a corresponding set of possible responses including a correct response corresponding to the particular category and one or more distractor responses not corresponding to the particular category is generated. The multiple-choice quiz question and the corresponding set of possible responses are presented. Example manners of presenting the multiple-choice quiz question and the corresponding set of possible responses are also disclosed.

### TECHNICAL FIELD

The present application relates to status indications and, more particularly, to providing status indications in the form of multiple-choice questions.

### BACKGROUND

User interfaces may include status indications related to a variety of conditions. Status indications may take the form of alerts or pop-ups related to particular conditions. Typically, indications include a text message or visual indicator directly identifying or describing the detected condition.

### BRIEF DESCRIPTION OF THE DRAWINGS

Embodiments are described in detail below, with reference to the following drawings:

FIG. 1 is a schematic operation diagram illustrating an operating environment of an example embodiment including a server computing device and a mobile computing device;

FIG. 2 is high-level schematic diagram of the server computing device of FIG. 1;

FIG. 3 shows a simplified organization of software components stored in a memory of the server computing device of FIG. 1;

FIG. 4 is a flowchart showing operations performed by the server computing device of FIG. 1 in providing a status indication in the form of a multiple-choice question;

FIG. 5 shows the mobile computing device of FIG. 1;

FIG. 6 is a high-level schematic diagram of the mobile computing device of FIG. 1;

FIG. 7 shows a simplified organization of software components stored in a memory of the mobile computing device of FIG. 1;

FIG. 8 is a flowchart showing operations performed by the mobile computing device of FIG. 1 in presenting a status indication in the form of a multiple-choice question;

FIG. 9 shows an example user interface for use in presenting a status indication in the form of a multiple-choice question;

FIG. 10 shows another example user interface for use in presenting a status indication in the form of a multiple-choice question;

FIG. 11 shows yet another example user interface for use in presenting a status indication in the form of a multiple-choice question;

FIG. 12 is a flowchart showing operations performed by the server computing device of FIG. 1 in providing a status indication related to consumption of quantities in terms of dynamically-defined units;

FIG. 13 is a flowchart showing operations performed by the mobile computing device of FIG. 1 in presenting a status indication related to consumption of quantities in terms of dynamically-defined units; and

FIG. 14 shows an example user interface for use in presenting a status indication related to consumption of quantities in terms of dynamically-defined units.

Like reference numerals are used in the drawings to denote like elements and features.

### DETAILED DESCRIPTION OF VARIOUS EMBODIMENTS

According to the subject matter of the present application, there may be provided a computer system. The computer system may include a processor, a communications module coupled to the processor, and a memory coupled to the processor. The memory may store instructions that, when executed by the processor, cause the computer system to: receive, using the communications module from one or more remote computing devices via a computer network, records related to a plurality of transfers for one or more accounts, the transfers corresponding to a plurality of categories; identify, based on the transfers corresponding to a particular category of the plurality of categories, a net outflow from the one or more accounts for a defined period for the particular category; determine that an amount of the net outflow for the defined period for the particular category exceeds an expected outflow for the defined period for the particular category; further to determining that the amount of the net outflow for the defined period for the particular category exceeds the expected outflow for the defined period for the particular category, generate a multiple-choice quiz question and a corresponding set of possible responses including a correct response corresponding to the particular category and one or more distractor responses not corresponding to the particular category; and provide the multiple-choice quiz question and the corresponding set of possible responses for presentation in association with the one or more accounts.

In this way, an indication of a condition, namely that the net outflow exceeds the expected outflow for a category, can be provided in an indirect manner. For example, a user may be provided with an indication that they are going overbudget with spending in a category based on their spending compared to their intended budget. Conveniently, such an indirect indication may be viewed more favourably by a user than a direct notification; the latter potentially seeming accusatory while the former is more discreet.

In some implementations, the multiple-choice quiz question may be based on the net outflow for the defined period for the particular category.

In some implementations, it may be that each response of the set of possible responses corresponds to a respective category of the plurality of categories.

In some implementations, it may be that the particular category is one of a set of tracked categories.

In some implementations, generating the corresponding set of possible responses may include validating the one or more distractor responses to confirm they do not correspond to the particular category.

In some implementations, generating the multiple-choice quiz question may include: selecting a multiple-choice quiz question template from amongst a plurality of multiple-choice quiz question templates; and populating the selected multiple-choice quiz question template based on at least the particular category to yield the multiple-choice quiz question.

In some implementations, categories of the plurality of categories may correspond to a plurality of merchant classes. The one or more of the records may indicate merchant classes associated with transfers related to those records. It may be that identifying, based on the transfers corresponding to the particular category of the plurality of categories, the net outflow from the one or more accounts for the defined period for the particular category includes identifying records indicating merchant classes corresponding to the particular category.

In some implementations, categories of the plurality of categories may correspond to a plurality of merchants. The one or more of the records may indicate merchants associated with transfers related to those records. Identifying, based on the transfers corresponding to the particular category of the plurality of categories, the net outflow from the one or more accounts for the defined period for the particular category may include identifying records indicating merchants corresponding to the particular category.

In some implementations, the instructions, when executed by the processor may further cause the computer system to: determine the expected outflow for the defined period for the particular category based on at least one of a net outflow for the particular category for an earlier period and information related to transfers in the particular category for one or more other accounts, the other accounts not associated with an owner of the one or more accounts.

In some implementations, the instructions, when executed by the processor may further cause the computer system to: prior to determining that the net outflow from the one or more accounts for the defined period for the particular category exceeds the expected outflow for the defined period for the particular category, receive an indication of user-input defining the expected outflow for the defined period for the particular category.

According to the subject matter of the present application, there may be provided a computer-implemented method. The method may include: receiving, from one or more remote computing devices via a computer network, records related to a plurality of transfers for one or more accounts, the transfers corresponding to a plurality of categories; identifying, based on the transfers corresponding to a particular category of the plurality of categories, a net outflow from the one or more accounts for a defined period for the particular category; determining that an amount of the net outflow for the defined period for the particular category exceeds an expected outflow for the defined period for the particular category; further to determining that the amount of the net outflow for the defined period for the particular category exceeds the expected outflow for the defined period for the particular category, generating a multiple-choice quiz question and a corresponding set of possible responses including a correct response corresponding to the particular category and one or more distractor responses not corresponding to the particular category; and providing the multiple-choice quiz question and the corresponding set of possible responses for presentation in association with the one or more accounts.

In some implementations, the multiple-choice quiz question may be based on the net outflow for the defined period for the particular category.

In some implementations, each response of the set of possible responses may correspond to a respective category of the plurality of categories.

In some implementations, generating the corresponding set of possible responses may include validating the one or more distractor responses to confirm they do not correspond to the particular category.

In some implementations, the method may further include: determining the expected outflow for the defined period for the particular category based on at least one of a net outflow for the particular category for an earlier period and information related to transfers in the particular category for one or more other accounts, the other accounts not associated with an owner of the one or more accounts.

In some implementations, it may be that the method further include: prior to determining that the net outflow from the one or more accounts for the defined period for the particular category exceeds the expected outflow for the defined period for the particular category, receiving an indication of user-input defining the expected outflow for the defined period for the particular category.

According to the subject matter of the present application, there may be provided a computer system. The computer system may include a processor, a communications module coupled to the processor, an input module coupled to the processor, an output module coupled to the processor, and a memory coupled to the processor. The memory may store instructions that, when executed by the processor, cause the computer system to: receive, using the communications module from a remote server system via a computer network, a multiple-choice quiz question and a corresponding set of possible responses including a correct response corresponding to a particular category of a plurality of categories and one or more distractor responses not corresponding to the particular category, the particular category associated with a net outflow from one or more accounts for a defined period that exceeds an expected outflow for the defined period for the particular category; present, using the output module, the multiple-choice quiz question and the set of possible responses; receive, using the input module, input selecting a response from the set of possible responses; and further to receiving the input, provide an indication based on the selected response.

In some implementations, it may be that the indication indicates at least one of the particular category and the amount of the net outflow for the defined period for the particular category.

In some implementations, it may be that the multiple-choice quiz question is presented during loading of an application by the computer system.

In some implementations, it may be that providing the indication based on the selected response includes: determining that the received input selected the correct response; and responsive to determining that the received input selected the correct response, awarding at least one of one or more points and one or more badges.

Other aspects and features of the present application will be understood by those of ordinary skill in the art from a review of the following description of examples in conjunction with the accompanying figures.

In the present application, the term “and/or” is intended to cover all possible combinations and sub-combinations of the listed elements, including any one of the listed elements alone, any sub-combination, or all of the elements, and without necessarily excluding additional elements.

In the present application, the phrase “at least one of . . . or . . . ” is intended to cover any one or more of the listed elements, including any one of the listed elements alone, any sub-combination, or all of the elements, without necessarily excluding any additional elements, and without necessarily requiring all of the elements.

Example embodiments of the present application are not limited to any particular operating system, system architecture, mobile device architecture, server architecture, or computer programming language.

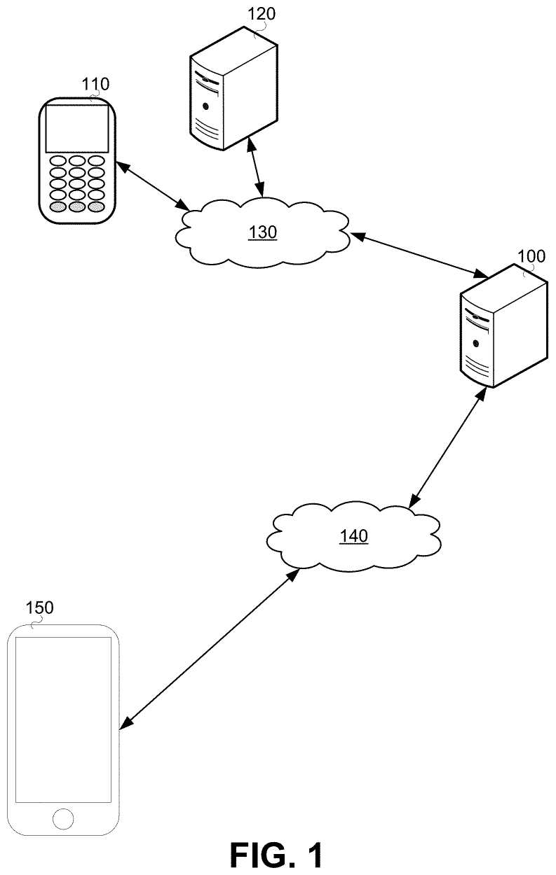

FIG. 1 is a schematic operation diagram illustrating an operating environment of an example embodiment.

As illustrated, a server computer system 100 communicates with remote computing devices via a network 130. The remote computing devices may take a variety of forms. For example, as illustrated, the server computer system 100 may communicate with one or more point-of-sale terminals and/or one or more other server computing devices including an example point-of-sale terminal 110 and an example remote computer system 120. The server computer system 100 may, as shown, also communicate with a mobile computing device 150 via a network 140.

The server computer system 100, point-of-sale terminal 110, the example remote computer system 120, and the mobile computing device 150 may be in geographically disparate locations. Put differently, each of the server computer system 100, the point-of-sale terminal 110, the example remote computer system 120 and the mobile computing device 150 may be remote from others of the server computer system 100, the point-of-sale terminal 110, the example remote computer system 120 and the mobile computing device 150.

The server computer system 100, the point-of-sale terminal 110, the example remote computer system 120 and the mobile computing device 150 are each both a computer system and a computing device.

As further described below, the server computer system 100 is adapted to provide status indications. For example, the server computer system 100 may provide status indications in the form of multiple-choice questions and/or status indications relating to consumption of quantities using units dynamically-defined based on the consumption.

The point-of-sale terminal 110 is a payment terminal. The point-of-sale terminal 110 captures information related to transactions including amounts of intended payments and information related to payment devices. The information may be transmitted over a short-range communication system, such as an NFC interface. The point-of-sale terminal 110 uses this information in order to determine whether a transaction is to be approved or declined. Accordingly, the point-of-sale terminal 110 may be a source of records relating to transfers to/from one or more accounts such as, for example, accounts associated with particular payment methods.

The example remote computer system 120 may correspond to one or more types of servers. For example, the example remote computer system 120 may be a database or other storage server such as may, for example, store information relating to transactions for one or more or more accounts. In a particular example, the example remote computer system 120 may store information relating to transactions in accounts associated with a financial institution such as, for example, a bank. Accordingly, the example remote computer system 120 may be a source of records relating to transfers to/from one or more accounts such as, for example, bank accounts and/or payment card accounts.

The network 130 is a computer network. In some embodiments, the network 130 may be an internetwork such as may be formed of one or more interconnected computer networks. For example, the network 130 may be or may include an Ethernet network, an asynchronous transfer mode (ATM) network, a wireless network, or the like. Additionally or alternatively, the network 130 may be or may include one or more payment networks.

The network 140 is also a computer network akin to the network 130 and similar considerations and possibilities apply. In some embodiments, the network 140 may be the same network as the network 130 and/or one of the network 130 and the network 140 may be a sub-network of the other of the network 130 and the network 140.

As further described below, the mobile computing device 150 is adapted to present one or more status indications. The mobile computing device 150 may co-operate with the server computer system 100 to present status indications in various forms using an output device. For example, the mobile computing device 150 may present status indications in the form of multiple-choice questions and/or status indications relating to consumption of quantities using units dynamically-defined based on the consumption.

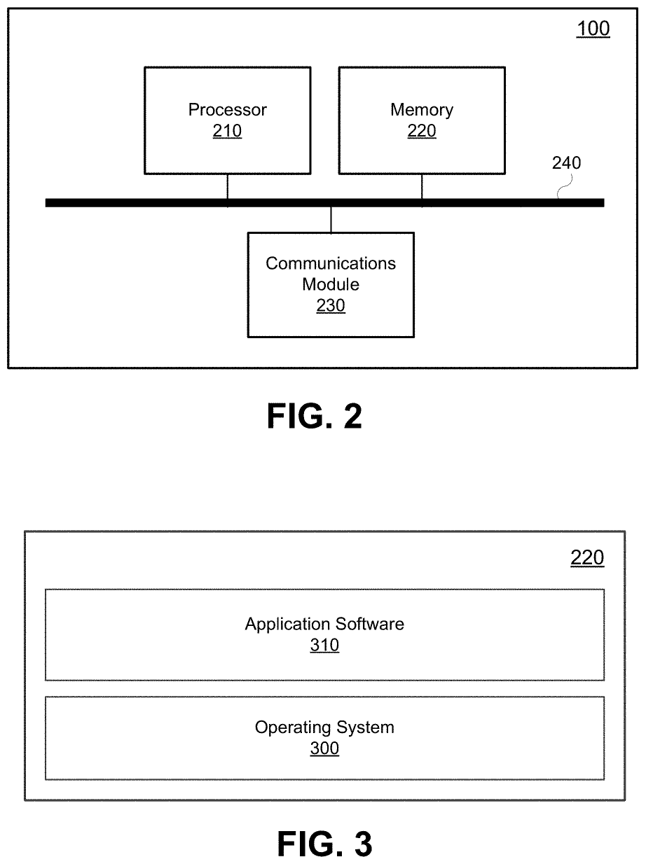

FIG. 2 is a high-level schematic diagram of a server computer system 100.

The server computer system 100 includes a variety of modules. For example, as illustrated, the server computer system 100 may include a processor 210, a memory 220, and/or a communications module 230. As illustrated, the foregoing example modules of the server computer system 100 are in communication over a bus 240.

The processor 210 is a hardware processor. The processor 210 may, for example, be one or more ARM, Intel x86, PowerPC processors or the like.

The memory 220 allows data to be stored and retrieved. The memory 220 may include, for example, random access memory, read-only memory, and persistent storage. Persistent storage may be, for example, flash memory, a solid-state drive or the like. Read-only memory and persistent storage are a non-transitory computer-readable storage medium. A computer-readable medium may be organized using a file system such as may be administered by an operating system governing overall operation of the server computer system 100.

The communications module 230 allows the server computer system 100 to communicate with other computing devices and/or various communications networks such as, for example, the network 130 and/or the network 140. The communications module 230 may allow the server computer system 100 to send or receive communications signals. Communications signals may be sent or received according to one or more protocols or according to one or more standards. For example, the communications module 230 may allow the server computer system 100 to communicate via a cellular data network, such as for example, according to one or more standards such as, for example, Global System for Mobile Communications (GSM), Code Division Multiple Access (CDMA), Evolution Data Optimized (EVDO), Long-term Evolution (LTE) or the like. Additionally or alternatively, the communications module 230 may allow the server computer system 100 to communicate via Wi-Fi™, using Bluetooth™ or via some combination of one or more networks or protocols. In some embodiments, all or a portion of the communications module 230 may be integrated into a component of the server computer system 100. For example, the communications module 230 may be integrated into a communications chipset.

Software comprising instructions is executed by the processor 210 from a computer-readable medium. For example, software may be loaded into random-access memory from persistent storage of the memory 220. Additionally or alternatively, instructions may be executed by the processor 210 directly from read-only memory of the memory 220.

FIG. 3 depicts a simplified organization of software components stored in the memory 220 (FIG. 2) of the server computer system 100. As illustrated, these software components include an operating system 300 and an application software 310.

The operating system 300 is software. The operating system 300 allows the application software 310 to access the processor 210 (FIG. 2), the memory 220, and the communications module 230 of the server computer system 100 (FIG. 2). The operating system 300 may be, for example, UNIX™, Linux™, Microsoft™ Windows™, Apple OSX™ or the like.

For example, the application software 310 may cooperate with the operating system 300 to adapt a suitable embodiment of the server computer system 100 to provide status indications in one or more forms.

Different types of status indications will be discussed in turn. First, manners of providing and presenting status indications in the form of multiple-choice questions will be discussed. Then, manners of providing and presenting status indications relating to consumption of quantities using units dynamically-defined based on the consumption will be discussed. Notably, either of these forms of status indications may be variously provided and/or presented by systems alone or in combination.

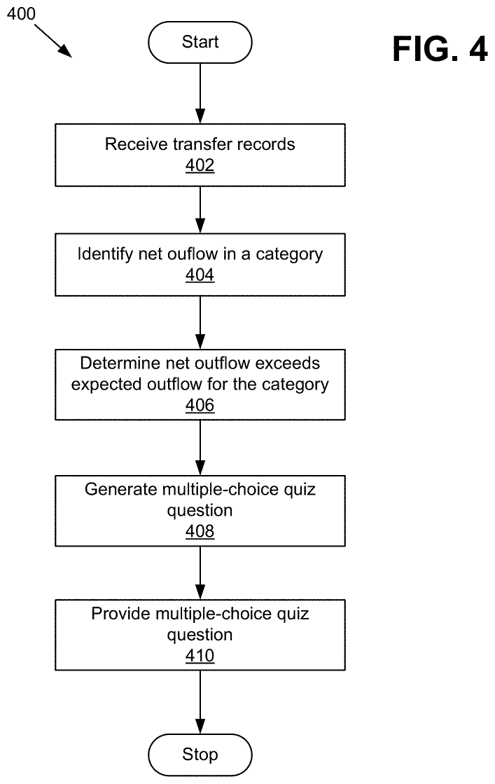

FIG. 4 provides a flowchart depicting example operations performed in a method 400 of providing a status indication in the form of a multiple-choice question. Operations starting with an operation 402 and continuing onward are performed by the processor 210 (FIG. 2) of the server computer system 100 executing software comprising instructions such as may be stored in the memory 220 of the server computer system 100.

At the operation 402, records related to transfers from one or more accounts are received by the server computer system 100.

As mentioned, the records relate to transfers for one or more accounts. For example, each record may correspond to a transfer to and/or from a given account. In a particular example, records may correspond to credits to and/or debits from accounts such, as for, example financial institution (e.g., bank or credit union) and/or payment card accounts (e.g., credit card accounts). In a particular example, the records may correspond to purchase transactions. The transfers (and hence the records) may have associated amounts (e.g., amounts of credits and/or debits from accounts and/or amounts of purchases).

The transfers to which the records relate correspond to categories. For example, the transfers may relate to categories of purchases, income and/or expenses such as, for example, transportation, dining out, grocery, gas, shopping, etc.. In some implementations, records may reflect a category associated with transfers to which the records relate. Additionally or alternatively, the categories may correspond to particular merchants and this correspondence may be used to determine categories to which records relate. For example, particular merchants may map to particular categories. Accordingly, it may be that records indicate merchants associated with transfers related to those records and that records correspond to categories based on the category (or categories) to which associated merchants relate. In another example, it may, additionally or alternatively, be that categories correspond to merchant classes. For example, records may indicate a merchant class associated with transfers related to those records. Additionally or alternatively, records may indicate a merchant as mentioned above, and metadata may be provided (in the records and/or separately) mapping merchants to merchant classes. For example, it could be that such metadata is used to determine a merchant class for transfers associated with a given record based on a merchant indicated by that record. In any event, it may be that records are directly indicative or somehow otherwise associated with a merchant class and correspond to categories based on the category (or categories) to which the associated merchant class relates.

The records may also indicate other information related to transfers such as, for example, dates, times, and/or locations identifying when and/or where particular transfers occurred and/or were initiated and/or made.

The records are received from remote computing devices such as, for example, from the point-of-sale terminal 110 and/or the example remote computer system 120. The records are received via a network such as, for example, the network 130. The records may be received via the network using the communications module 230.

Following the receipt of records at the operation 402, an operation 404 is next.

At the operation 404, the transfers corresponding to a particular category—i.e., a particular one of the categories to which transfers may relate—are identified. The identified transfers are then analyzed. In particular, based on the transfers corresponding to the particular category, a net outflow for a defined period from accounts to which the transfers relate (e.g., the one or more accounts) is identified. For example, it could be that the net outflow is identified by totalling amounts of the transfers (e.g., amounts debited and credited from the various accounts) and then a net amount of the transfers is determined. Notably, the amount of the net outflow may be positive and/or negative depending on whether there was outflow or inflow (which is a negative outflow) from the account during the period.

The particular category may be identified in a variety of manners. For example, the particular category may be one for which tracking has been enabled—e.g., a user may have added it to a set of tracked categories. Additionally or alternatively, it may be that the particular category is one of several categories being evaluated to determine whether status indication related to one or more of those categories is required. In a particular example, it could be that the method 400 is run for each of those categories in turn such as, for example, in series, in parallel, or in some combination thereof.

As mentioned above, the records related to transfers correspond to transfers for one or more accounts and those accounts may be financial accounts. Accordingly, a net outflow for a defined period may correspond to a net outflow of currency (e.g., dollars) from an account or a set of accounts in aggregate. In a particular example, the net outflow may correspond to a total of all payments sourced on the one or more accounts during a defined period less any income deposited in those accounts in that same period.

The defined period may take a variety of forms. For example, the defined period may be a month, a year, a quarter, a week, etc.. In some cases, the defined period may be a particular period associated with one or more categories. For example, it could be that the defined period for a category of household expenses is a calendar month. In another example, a category of fuel expenses could be considered on a weekly basis. In yet another example, a category of dining out may be considered on a daily basis (e.g., a per diem basis).

In some cases the defined period may be user-defined and/or user-selected. In other words, input may be received defining the period and/or selecting a defined period from amongst a set of options. In a particular example, the defined period may be/include a budgeting period such as may have been specified by a user—e.g., a user-specified budgeting period.

As further described below, there may be a budget associated with a particular category. For example, there may be a budget for each category and/or encompassing a set of categories. In a particular example, the one or more accounts may be associated with a user and the user may have a food budget encompassing grocery and dining out categories. In another particular example, there may be a fuel budget. Whether encompassing a single category or more than one category, such a budget may be defined in terms of a particular period. For example, the one or more account may be associated with a weekly fuel budget. That same period may be used as the defined period. Put another way, it may be that the defined period is determined based on a time period for a budget associated with the particular category.

As mentioned above, records may be associated with categories in a variety of manners. Accordingly, identifying transfers corresponding to the particular category may be performed in a corresponding variety of manners. Example manners of identifying transfers corresponding to a particular category will now be discussed. Notably, depending on the nature of the correspondence between records, transfers, and categories, one or more manners of identifying transfers corresponding to a particular category may be employed alone or in combination.

First, in the simplest case, some or all of the records may directly indicate a category. In such a circumstance, identifying transfers corresponding to the particular category may include filtering the records to find records indicating the particular category.

Second, it may, additionally or alternatively, be that categories correspond to merchants with the records potentially indicating merchants as discussed above. For example, in such a scenario, one or more of the records may indicate merchants associated with transfers related to those records. In such a circumstance, identifying transfers corresponding to the particular category may include identifying records indicating merchants corresponding to the particular category. For example, the records may be filtered to find records indicating a merchant that maps to the particular category.

Third, it may, additionally or alternatively, be that categories correspond to merchant classes with the records potentially directly (or indirectly) indicating merchant classes as discussed above. For example, in such a scenario, one or more of the records may indicate merchant classes associated with transfers related to those records. In such a circumstance, identifying transfers corresponding to the particular category may include identifying (or somehow indirectly indicating) records indicating merchant classes corresponding to the particular category. For example, the records may be filtered to find records indicating a merchant class that maps to the particular category.

Following the operation 404, an operation 406 is next. At the operation 406, the net outflow is compared to an expected outflow for the defined period for the particular category. Based on this comparison it may be determined that the amount of the net outflow for the defined period exceeds the expected outflow for the defined period for the particular category.

The expected outflow for the defined period for the particular category may be determined in a variety of manners.

In some cases, the expected outflow for the defined period for the particular category may be determined based on outflows in an earlier period (or earlier periods). For example, it could be that the outflow for a given period may be expected to be the same as in the immediately previous period and/or more than one previous period. In some cases, a rolling average may be employed, averaging spending in previous periods either on an equal basis and/or on a weighted basis (e.g., to favour the most recent previous periods).

Additionally or alternatively, the expected outflow for the defined period for the particular category may be determined based on information related to accounts other than the one or more accounts. Those other accounts may be accounts expected to be in some way predictive for the one or more accounts. For example, it could be that those other accounts relate to one or more owners with a profile similar in some relevant aspect to a profile of an owner of the one or more accounts. Put differently, the expected outflow may be determined for the defined period for the particular category for one or more other accounts not associated with the owner of the one or more accounts. Such other accounts and/or users may be identified in various manners such as, for example, by clustering user profiles and/or accounts to identify similar accounts with similar owners and/or activity profiles. However identified, transfers in those other accounts may be analyzed in various fashions (e.g., by computing some manner of average, weighted or otherwise) in order to arrive at an expected outflow for the one or more accounts.

Additionally or alternatively, it may be that the expected outflow for the defined period for the particular category is user-defined. For example, it could be that an indication of user-input defining the expected outflow for the defined period for the particular category is received by the server computer system 100, prior to performing the method 400 and, in particular, at least prior to determining that the net outflow from the one or more accounts for the defined period for the particular category exceeds the expected outflow.

Additionally, it could be that, as mentioned above, a budget is associated with the particular category and/or one or more categories including the particular category. For example, the received user-input may configure and/or define such a budget. In any event, however defined, a budget may be used in defining the expected outflow. For example, where there is a budget for the particular category for a period of time corresponding to the defined period, the expected outflow for the defined period for the particular category may be the budgeted amount. In another example, the amount of the budget may be scaled appropriately where there is a mismatch in periods. For example, where there is a monthly budget, the expected outflow for some smaller or larger period may be determined by a relative scaling of the monthly budget. In a particular example, an expected outflow for a week could be one-quarter of the monthly budget. In another particular example, an expected outflow for a week could seven times a daily budget.

Following the determination at the operation 406 that the net outflow for the defined period for the particular category exceeds the expected outflow for the defined period for the particular category, an operation 408 is next. If, however, no such exceedance is identified, the method 400 may terminate.

At the operation 408, further to determining that the amount of the net outflow for the defined period for the particular category exceeds the expected outflow for the defined period for the particular category at the operation 406, a multiple-choice question is generated. In particular, both a multiple-choice question and a corresponding set of possible responses are generated thereby providing a quiz question (a multiple-choice quiz question) and possible answers (the set of possible responses). The set of possible responses includes a correct response. The correct response corresponds to the particular category. The set of possible responses includes at least one distractor response (i.e., one or more distractor responses). The distractor response(s) are incorrect answers but are intended to be somewhat plausible choices. For example, where the correct responses correspond to the particular category, the distractor responses may correspond to other categories and thus not correspond to the particular category. In a particular example each of the distractor responses may correspond to a respective category and, with only the correct answer corresponding to the particular category, it may thus be that each response of the set of possible responses corresponds to a respective category.

Notably, the correct response corresponds to the condition being signalled and along with the multiple-choice quiz question acts as a status indication. Meanwhile, the distractors serve to enable the indirect nature of a notification by way of a quiz as compared, for example, to a direct indication of the exceedance condition.

The multiple-choice quiz question may relate to the net outflow for the defined period for the particular category. In a particular example, the multiple-choice quiz question may relate to the fact that the amount of the net outflow of the defined period for the particular category has been determined to exceed the expected outflow for the defined period for the particular category. Put another way, the multiple-choice quiz question (and its associated possible responses) may serve as a status indication such as may notify a user of the exceedance in an indirect manner. In other words, the multiple-choice quiz question may act as a “nudge”. For example, where the expected outflow relates to a budget for spending in a particular spending category and the net outflow relates to purchases in that category, the multiple-choice quiz question may serve to indirectly notify the user that they have gone over budget. In another example, where the expected outflow relates to spending in the particular category in an earlier period, the multiple-choice quiz question may serve to “nudge” a user whose spending is trending higher in the current, defined period so that they may, for example, trim back on spending in that category.

The multiple-choice quiz question and the set of possible responses may each be generated in a variety of manners.

First, it is noted that generation of the multiple-choice question may employ a variety of techniques. For example, it could be that a set of multiple-choice quiz questions (i.e., a question bank) is provided related to various conditions (“What category has gone over budget?”. “You're trending higher in a category - do you know which one?”). The generating of the multiple-choice quiz question may correspond to selecting a question from the question bank. For example, it could be that a question is selected based on that question relating to an identified condition such as, for example, a degree of exceedance of the expected outflow, the nature of the exceedance (e.g., overbudget for a period vs. over predicted spending for a period) and/or the particular category in which the exceedance occurred.

In another example, it could be that a set of template questions may be provided. A multiple-choice question template may be selected from such a set and then populated to yield the multiple-choice quiz question. For example, a template could be selected in manners similar to the selection of a question from a question bank. In a particular example, templates may be associated with various conditions and a particular template may be selected based on a correspondence with an identified condition. The population of the selected template may add a variety of information to the template question to generate the multiple-choice question. This populating may, for example, include filling in one or more fields of the template. For example, it could be that a selected multiple-choice quiz question template is populated based on information such as, for example, the particular category to yield the multiple-choice question. In a particular example, the template could include adding a hint (e.g., based on the particular category) to the question template such as, for example, by populating a hint field of the template. A example of a hint related to a fuel category could be, for example, “Vroom vroom” and the resulting multiple choice quiz-question where net outflow in the category of fuel for a defined period has exceeded expected outflow on fuel for that period could be “Vroom vroom—your spending is high in a category—do you know which one?”

The set of possible responses may also be generated in a variety of manners.

For example, the correct response may, since it corresponds to the particular category, may be simply a name or identifier of the category thereby signalling the category for which status is being signalled. Notably, the multiple-choice quiz question includes information identifying the condition, thereby allowing the two (the question and the correct answer) to act together in concert as a status indication/status notification as mentioned above.

Generation of distractor responses may involve validation to ensure the distractors are actually incorrect answers. Such validation may involve determination of information related to other transfers not considered in determining the net outflow. For example, where the multiple-choice quiz question prompts for the category in which there is an exceedance, it may be that the distractors are validated by determining net outflows for categories to which they correspond and determining that those net outflows do not exceed expected outflow for those categories for the defined period. In another example, where the correct answer and distractor responses are not indications of categories but rather somehow relate to a supposed property of the category, the distractors may be validated to confirm that they do not confirm to the particular category. In a particular example, the multiple-choice question could prompt “How much are you overbudget on fuel this month?” and the correct answer may be “$50” while possible distractor responses could include “$20” and “5%”. In such a circumstance, it might be necessary to, for example, validate the 5% distractor to confirm that it doesn't correspond to $500 (e.g., as could be the case where the expected outflow on fuel was $1000 for the defined period).

Following the generation of the multiple-choice quiz question at the operation 408, an operation 410 is next.

At the operation 410, the multiple-choice question and the set of possible responses generated at the operation 408 is provided for presentation. For example, the question and the set of possible responses may be provided for presentation in association with one or more of the one or more accounts. Such provision may take a variety of forms. For example, the multiple-choice quiz question and the set of possible responses may be sent to another computing device associated with a user (e.g., the mobile computing device 150) for presentation. Additionally or alternatively, the multiple-choice quiz question and the possible responses to it may be queued for later retrieval by and/or sending to such a remote computing device for presentation. Notably, where multiple-choice quiz questions and corresponding possible responses are so queued, an expiration time may be associated with the queue and/or each question therein so that questions can be discarded before they become irrelevant. Additionally or alternatively, queued questions may be tagged with metadata related to the condition they are intended to signal and may be reviewed periodically and/or at dequeue in order to validate they are still relevant before providing them for presentation. The multiple-choice quiz question and the set of possible responses may be sent to the mobile computing device 150 by way of the network 140 such as, for example, using the communications module 230.

The above description of the method 400 is by way of example and is capable of variation. For example, it could be that in some cases the records received at the operation 402 are processed immediately according to the rest of the method 400 (e.g., according to operation 404 and onward). Additionally or alternatively, it may be that in some cases some or all of the records may be queued for later processing. For example, records may be accumulated in a database and later processed according to operations 404 and onward of the method 400 such as, for example, on a periodic basis.

In another example of a variation, as discussed above questions may be generated to signal the condition of exceeding expected outflow. However, multiple-choice quiz questions may, additionally or alternatively, be generated in order to provide status indications for other conditions. For example, it could be that multiple-choice quiz questions are generated to highlight that net transfers are trending below expectation. Put differently, multiple-choice-quiz-question-based status indications may be provided in order to signal desirable, rather than undesirable conditions. In another example, multiple-choice-quiz-question-based status indications may be provided in advance of an exceedance of an expected outflow such as for example, when the net outflow reaches half the expected outflow for a period.

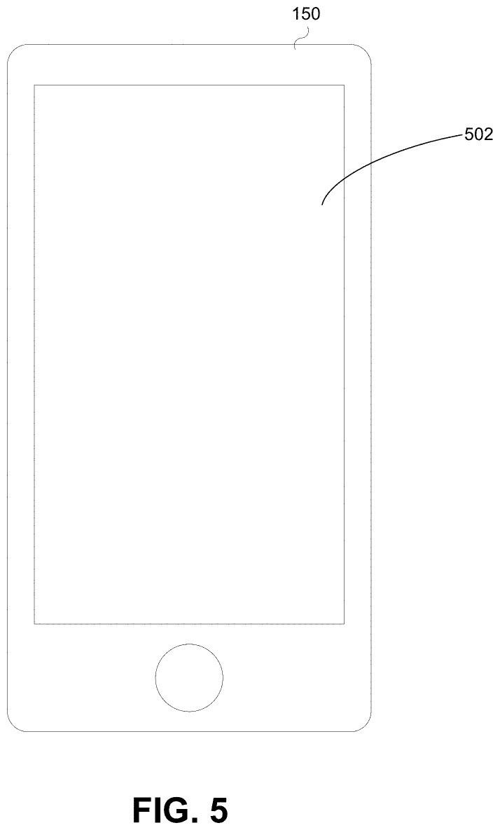

FIG. 5 will now be discussed. FIG. 5 shows the front of the mobile computing device 150. The mobile computing device 150 may, in some embodiments, be a smartphone as shown in FIG. 5. In other embodiments, the mobile computing device 150 may be another form of mobile computing device such as, for example, a tablet.

As illustrated, the front of the mobile computing device 150 includes a display 502. The display 502 is a module of the mobile computing device 150. The display 502 is for presenting graphics. The display 502 may be, for example, a liquid crystal display (LCD). In addition to being an output device, the display 502 may also be an input device. For example, the display 502 may allow touch input to be provided to the mobile computing device 150. In other words, the display 502 may be a touch sensitive display module. In a particular example, the display 502 may be a capacitive touch screen.

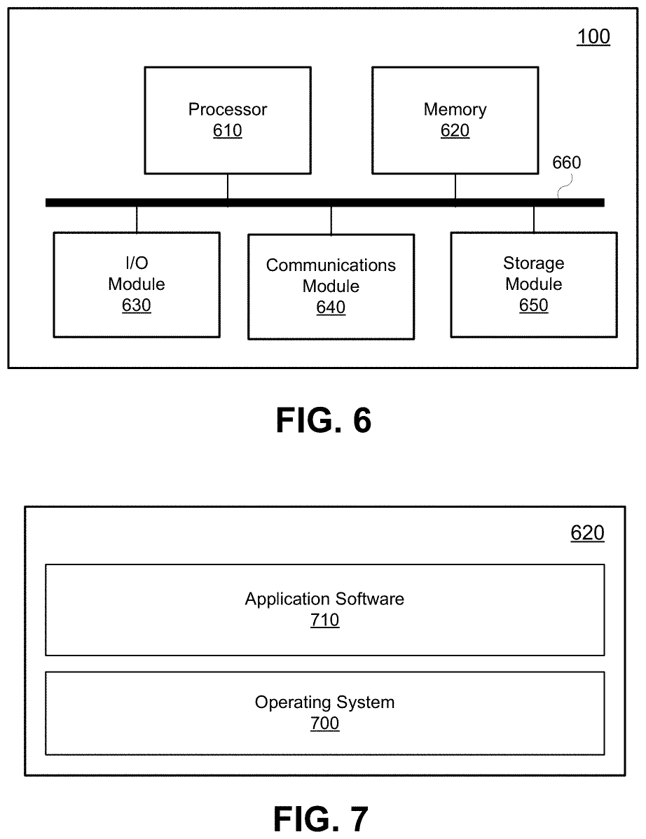

FIG. 6 is a high-level schematic diagram of the mobile computing device 150.

The mobile computing device 150 includes a variety of modules. For example, as illustrated, the mobile computing device 150 may include a processor 610, a memory 620, a communications module 640, an I/O module 630, and/or a storage module 650. As illustrated, the foregoing example modules of the mobile computing device 150 are in communication over a bus 660.

The processor 610 is a hardware processor. The processor 610 may, for example, be one or more ARM, Intel x86, PowerPC processors or the like.

The memory 620 allows data to be stored and retrieved. The memory 620 may include, for example, random access memory, read-only memory, and persistent storage. Persistent storage may be, for example, flash memory, a solid-state drive or the like. Read-only memory and persistent storage are a non-transitory computer-readable storage medium. A computer-readable medium may be organized using a file system such as may be administered by an operating system governing overall operation of the mobile computing device 150.

The I/O module 630 is an input module and an output module. As an input module, the I/O module 630 allows the mobile computing device 150 to receive input from components of the mobile computing device 150. As an output module, the I/O module 630 allows the mobile computing device 150 to provide output to components of the mobile computing device 150. For example, the I/O module 630 may allow the mobile computing device 150 to provide output to and/or receive input from the display 502.

The communications module 640 allows the mobile computing device 150 to communicate with other computing devices and/or various communications networks, such as, for example, the network 140. The communications module 640 may allow the mobile computing device 150 to send or receive communications signals. Communications signals may be sent or received according to one or more protocols or according to one or more standards. For example, the communications module 640 may allow the mobile computing device 150 to communicate via a cellular data network, such as for example, according to one or more standards such as, for example, Global System for Mobile Communications (GSM), Code Division Multiple Access (CDMA), Evolution Data Optimized (EVDO), Long-term Evolution (LTE) or the like. Additionally or alternatively, the communications module 640 may allow the mobile computing device 150 to communicate using near-field communication (NFC), via Wi-Fi™, using Bluetooth™ or via some combination of one or more networks or protocols. In some embodiments, all or a portion of the communications module 640 may be integrated into a component of the mobile computing device 150. For example, the communications module may be integrated into a communications chipset.

The storage module 650 allows data to be stored and retrieved. In some embodiments, the storage module 650 may be formed as a part of the memory 620 and/or may be used to access all or a portion of the memory 620. Additionally or alternatively, the storage module 650 may be used to store and retrieve data from persisted storage other than the persisted storage (if any) accessible via the memory 620. In some embodiments, the storage module 650 may be used to store and retrieve data in/from a database. A database may be stored in persisted storage. Additionally or alternatively, the storage module 650 may access data stored remotely such as, for example, as may be accessed using a local area network (LAN), wide area network (WAN), personal area network (PAN), and/or a storage area network (SAN). In some embodiments, the storage module 650 may access data stored remotely using the communications module 640. In some embodiments, the storage module 650 may be omitted and its function may be performed by the memory 620 and/or by the processor 610 in concert with the communications module 640 such as, for example, if data is stored remotely.

Software comprising instructions is executed by the processor 610 from a computer-readable medium. For example, software may be loaded into random-access memory from persistent storage of the memory 620. Additionally or alternatively, instructions may be executed by the processor 610 directly from read-only memory of the memory 620.

FIG. 7 depicts a simplified organization of software components stored in the memory 620 of the mobile computing device 150. As illustrated, these software components include an operating system 700 and an application software 710.

The operating system 700 is software. The operating system 700 allows the application software 710 to access the processor 610 (FIG. 6), the memory 620, the communications module 640, the I/O module 630, and the storage module 650 of the mobile computing device 150. The operating system 700 may be, for example, Google™ Android™, Apple™ iOS™, UNIX™, Linux™, Microsoft™ Windows™, Apple OSX™ or the like.

The application software 710 adapts the mobile computing device 150, in combination with the operating system 700, to operate as a device for presenting status indications. Where the mobile computing device 150 is a smartphone or tablet, the application software 710 may itself be or may be a part of a smartphone or tablet application or “app”. In a particular example, the application software 710 may correspond to an online banking and/or personal finance app.

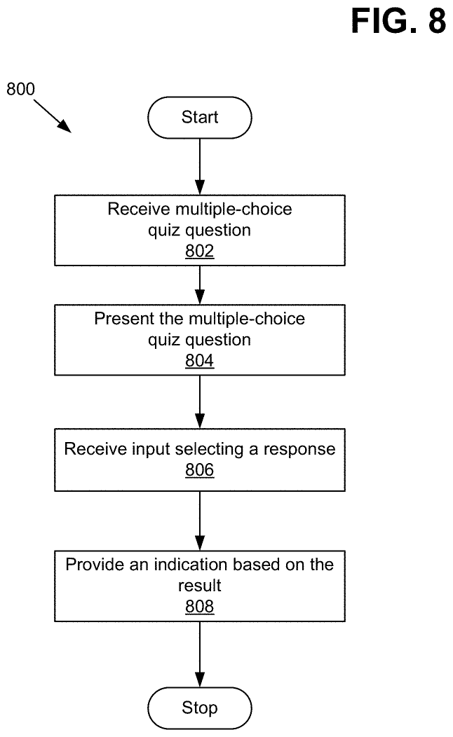

FIG. 8 provides a flowchart depicting example operations performed in a method 800 of presenting a status indication in the form of a multiple-choice question. Operations starting with an operation 802 and continuing onward are performed by the processor 610 (FIG. 2) of the mobile computing device 150 executing software comprising instructions such as may be stored in the memory 620 of the mobile computing device 150.

At the operation 802, a multiple-choice quiz question and a corresponding set of possible responses are received. The set of possible responses includes a correct response corresponding to a particular category selected from a set of categories and one or more distractor responses not corresponding to the particular category. The particular category may be associated with a net outflow from one or more accounts for a defined period that exceeds an expected outflow for the defined period for the particular category.

The multiple-choice quiz question and the corresponding set of possible responses may be received by the mobile computing device 150 from a remote computer system such as, for example, the server computer system 100. The multiple-choice quiz question and the corresponding set of possible responses may be received via the network 140 such as, for example, using the communications module 640. In a particular example, the mobile computing device 150 may receive the multiple-choice quiz question and the corresponding set of possible responses from server computer system 100 via the network 140 using the communications module 640.

Notably, the multiple-choice quiz question and the corresponding set of possible responses received at the operation 802 by the mobile computing device 150 may correspond to the multiple-choice quiz question and the corresponding set of possible responses provided by the server computer system 100 at the operation 410 of the method 400 (FIG. 4).

Following receipt of the multiple-choice quiz question and the corresponding set of possible responses at the operation 802, an operation 804 is next.

At the operation 804, the mobile computing device 150 presents the multiple-choice quiz question and the corresponding set of possible responses. For example, the mobile computing device 150 may present these using an output module such as, for example, the I/O module 630. For example, the mobile computing device 150 may use the output module to present the multiple-choice quiz question such as, for example, using the display 502.

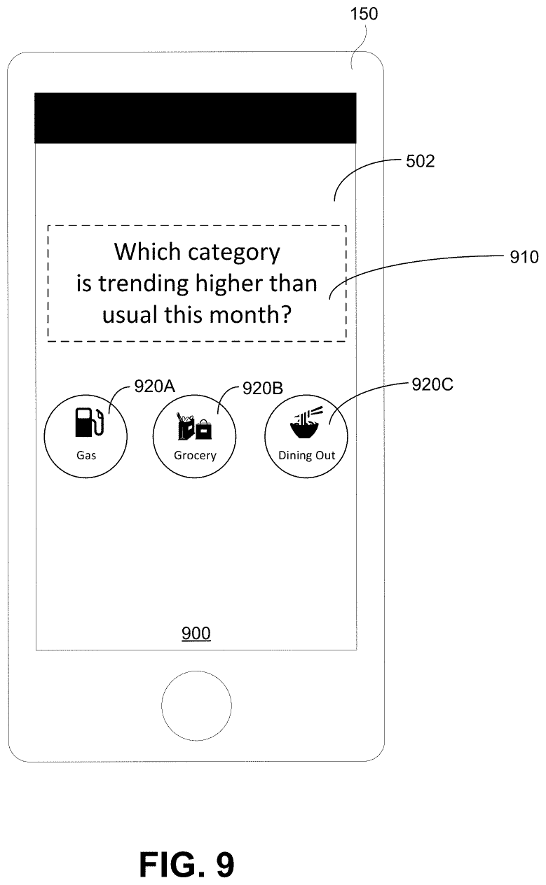

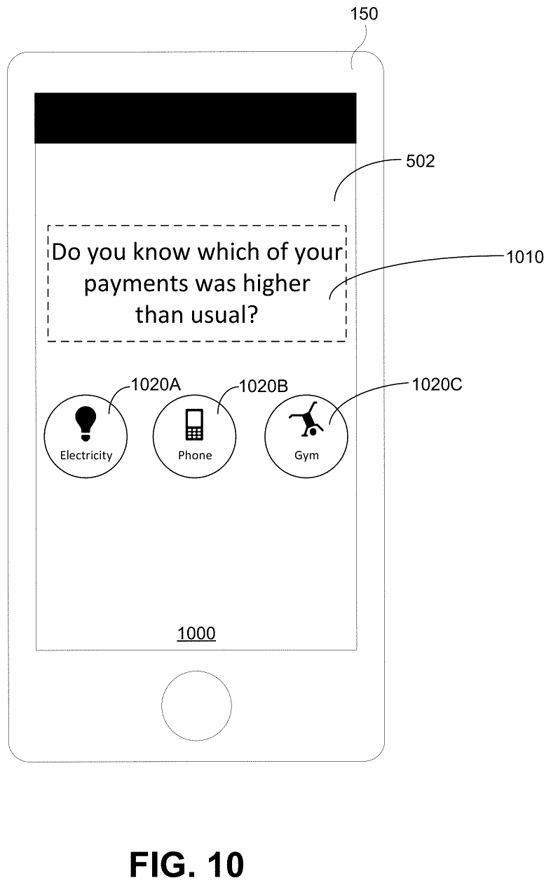

Examples of presenting a multiple-choice quiz question and possible responses thereto will now be discussed with reference to FIGS. 9 and 10.

FIG. 9 shows a user interface for use in presenting a multiple-choice quiz question and possible responses.

As illustrated, the display 502 of the mobile computing device 150 may present an example user interface 900. The example user interface 900 includes a prompt 910 and a set of response buttons 920A-920C.

The prompt 910 includes text such as may correspond to the multiple-choice quiz question received at the operation 802. For example, it may be that the prompt 910 is simply a rendering of the text of the multiple-choice quiz question.

Each of the response buttons 920A-920C corresponds to a category. One of the response buttons corresponds to the correct response from the set of possible responses. The others of the response buttons correspond to distractor responses. For example, where the particular category to which the correct response corresponds is “dining out”, the prompt 920C may correspond to the correct answer while the response buttons 920A and 920B may each correspond to a distractor response.

A second example user interface 1000 for use in presenting a multiple-choice quiz question and possible responses thereto is shown in FIG. 10.

As illustrated, the second example user interface 1000 includes a prompt 1010. The prompt 1010 is akin to the prompt 910 (FIG. 9). The second example user interface 1000 also includes a set of response buttons 1020A-1020C. Each of the response buttons 1020A, 1020B and 1020C may correspond to a set of possible responses in manners similar to as was described above for the response buttons 910A-910C (FIG. 9).

However presented, following the presentation of the multiple-choice quiz question and the set of possible responses at the operation 804, an operation 806 is next.

At the operation 806, input selecting a response is received. For example, input selecting a response from amongst the set of possible responses may be received such as, for example, using an input module such as, for example, the I/O module 630.

The received input may take a variety of forms. For example, input may be received interacting with a response button such as, for example, the response buttons 920A-920C (FIG. 9) or the response buttons 1020A-1020C (FIG. 10). In a particular example, where the display 502 is a touchscreen, the received input may correspond to a touch interaction with a response button.

Following the operation 806, an operation 808 is next.

At the operation 808, further to receiving the input at the operation 806, an indication based on the response selected at the operation 806 is provided by the mobile computing device 150. Providing the indication may include providing output such as, for example, one or more of a visual user interface, audio, or the like. Such output may be provided using an output module such as, for example, the I/O module 630. In a particular example, a user interface may be presented using the display 502 (FIG. 5).

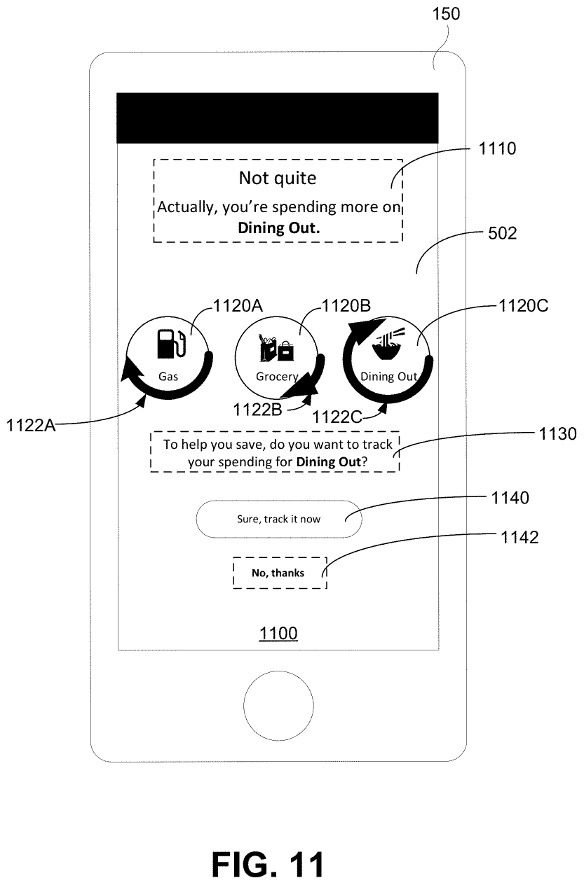

An example user interface 1100 for providing an indication based on a selected response is provided in FIG. 11. Notably, the example user interface is similar in visual form to the example user interface 900 and may be employed in sequence with it.

As illustrated, the example user interface 1100 includes a message 1110, category indications 1120A-1120C, a prompt 1130, a first selectable option 1140, and a second selectable option 1142.

Providing the indication at the operation 808 may include determining whether the selected response is the correct response (rather than a distractor response). If it determined that the selected response is incorrect (i.e., the received input selected a distractor response), an indication to the effect may be provided. For example, as illustrated, the text of message 1110 suggests that the user chose an incorrect response (e.g., “gas” or “grocery”) rather than a correct answer (e.g., “dining out”). Similarly, if it is determined that the selected response was the correct response (i.e., the received input selected the correct response), a corresponding indication (e.g., different message text) may be provided. Additionally or alternatively, some other operation may be performed. For example, responsive to determining that the correct response was selected, points and/or badges may be awarded. In a particular example, the mobile computing device 150 may maintain a record of points and/or badges awarded to a user. Additionally or alternatively, the mobile computing device 150 may allow review of badges not yet earned. Additionally or alternatively, the mobile computing device 150 may allow a user to compare their score and/badges to those of other users such as, for example, by way of a leaderboard and/or a comparison with family and/or friends.

Notably, whether or not the correct response is selected, the indication may indicate the correct answer such as, for example, by indicating the particular category. Additionally or alternatively, depending on the nature of the multiple-choice question the indication may otherwise correspond to the particular category such as, for example, by providing an indication of the net outflow for the defined period for the particular category. For example, a graphic may be presented indicating the net outflow for the defined period for the particular category relative to the expected outflow for the defined period for the particular category. As illustrated, in the example user interface 1100, the message 1110 indicates the particular category while the category indications 1120A-1130C include respective indicators 1122A-1122C indicating outflow in each of the categories features in the various responses including the correct response of “dining out” which has its (relatively high) outflow indicated by the indicator 1122C of the category indication 1120C.

Other options and/or actions may be provided. For example, options may be provided allowing a user to take one or more actions further to the status indication that was provided by way of the multiple-choice quiz question. For example, selectable options may be provided related to the particular category. In particular, example, a prompt 1130 asks the user whether the particular category to which the multiple-choice quiz question corresponds should be tracked. Input may then be provided to begin tracking the category by selecting the first selectable option 1140 (e.g., by way of touch interaction with the first selectable option 1140). Alternatively, a user may opt not to track the particular category and may provide corresponding input—e.g., selecting the second selectable option 1142 such as, for example, by way of a touch interaction therewith.

In another example of a variation, it may, additionally or alternatively, be that, following presentation of a given multiple-choice quiz question status indication, one or more options related to the particular category are presented. For example, a user interface may be provided to allow a user to modify the expected outflow for the particular category (e.g., by editing an associated budget). In another example, a user interface may, additionally or alternatively, be provided to allow a review of transfers associated with the particular category such as, for example, transfers considered in determining the net outflow for the particular category for the defined period.

Status indications may be presented by the mobile computing device 150 such as, for example, according to the method 800 (FIG. 8) in a variety of circumstances. For example, the multiple-choice quiz question could be presented during loading of an application (e.g., a baking or a personal finance app such as may, for example, correspond to the application software 710 (FIG. 7)), when such an application or, more broadly, the mobile computing device 150 is idle, and/or responsive to a user request such as, for example, a request to play a quiz game.

The discussion now turns to manners of providing and presenting status indications relating to consumption of quantities using dynamically-defined units based on the consumption.

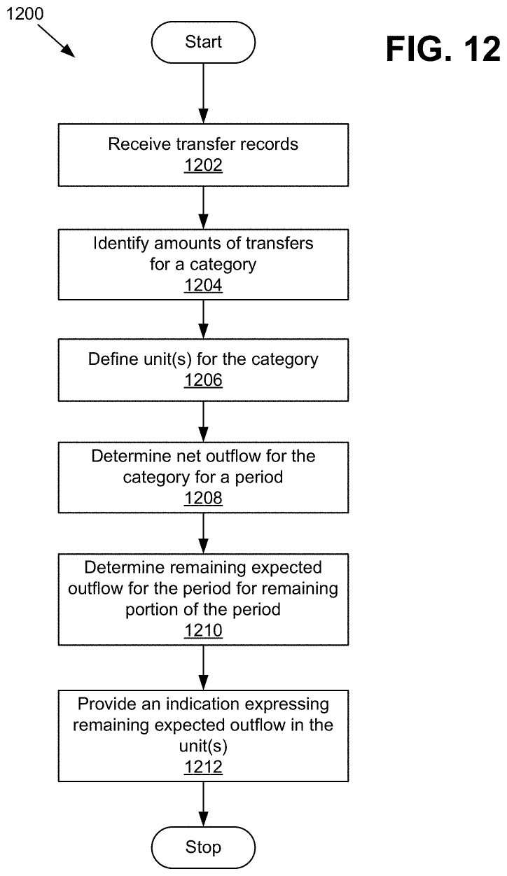

FIG. 12 provides a flowchart depicting example operations performed in a method 1200 of providing a status indication relating to consumption of quantities using units dynamically-defined based on the consumption. Operations starting with an operation 1202 and continuing onward are performed by the processor 210 (FIG. 2) of the server computer system 100 executing software comprising instructions such as may be stored in the memory 220 of the server computer system 100.

First, at the operation 1202, records related to transfers from one or more accounts are received by the server computer system 100. The operation 1202 is akin to the operation 402 (FIG. 4) of the method 400 and similar considerations apply as in that operation. For example, the records relate to transfers for one or more accounts. Further, such transfers correspond to categories from a set of categories and have associated amounts. For example, the transfer may correspond to purchases in one or more categories such as, for example, trips via taxi or ride-sharing, meals eating out, and/or visits to particular retailers or services. Additionally, as in the operation 402, the records may be received via a network from various remote computing devices. Broadly speaking, the behaviour of the server computer system 100 in performing the operation 1202 may, in some implementations, correspond to the behaviour of the server computer system 100 in performing the operation 402. Furthermore, it may be that, akin to as was discussed above in relation to the method 400, that the received records are processed immediately (e.g., according to the rest of the method 1200—i.e., operation 1204 and onward) or are queued (e.g., in a database) for later processing according to the rest of the method 1200.

Following the operation 1202, an operation 1204 is next.

At the operation 1204, one or more typical amounts of transfers corresponding to a particular category of a set of categories are identified. Notably, the particular category may be identified in a variety of manners such as, for example, manners as were discussed above in relation to the method 400 (FIG. 4). In a particular example, it may be that the particular category is a tracked category—e.g., one of (a member of) a set of tracked categories.

Typical amounts of transfers may be identified in a variety of manners. Example manners of identifying typical amounts of transfers corresponding to a particular category will now be discussed. As a preliminary matter, however, it is noted that it may be that some manners of identifying typical amounts of transfers includes identifying transfers corresponding to the particular category. Transfers corresponding to a particular category may be identified in manners such were discussed above in relation to the operation 404 (FIG. 4) of the method 400 including, for example, based on merchants and/or merchant categories.

In a first example of identifying typical amount(s) of transfers corresponding to a particular category, an average (e.g., a mean, mode, median, or some other manner of average such as, for example, a weighted average) may be determined for the amounts of some or all of the transfers corresponding to the particular category. In a particular example, one or more averages may be computed for transfers that occurred within particular periods. For example, it could be that recent transfers occurring within some period of time are averaged to identify the typical amounts.

In a second example of identifying typical amount(s) of transfers corresponding to a particular category, such an identification may include performing a cluster analysis of transfers corresponding to the particular category. As within averaging, such a cluster analysis may be performed on all transactions corresponding to the particular category or on transactions within some defined period. Various forms of cluster analysis such as may, for example, be known to skilled persons may be defined depending, for example, on the nature of the transactions. For example, it is possible that a cluster analysis may employ one or more of connectivity-based clustering, centroid-based clustering, distribution-based clustering, density-based clustering and/or one or more other techniques such as, for example, using genetic algorithms.

Following identification of the typical amount(s) at the operation 1204, an operation 1206 is next.

At the operation 1206, one or more units for the particular category are dynamically-defined based on the typical amount(s) of transfers corresponding to the particular category. As such, the unit(s) are dynamically-defined. The units may be dynamically-defined in a variety of manners. For example, it may be that one or more of the typical amounts are selected for use as units. Additionally or alternatively, the units may also be selected taking into account one or more intents. For example, it may be that the one or more units for the particular category are selected to correspond to typical purchases in the particular category (e.g., while ignoring outliers) such as, for example, based on frequency. Broadly speaking, the units are selected based on the typical amounts of the transfers and thus may be reflective of one or more underlying artifacts or commodities to which the transfers correspond. For example, where the transfers correspond to purchases (e.g., of rides or meals), the units are then units corresponding to those purchases (e.g., units of rides or meals). Put another way, where the transfers correspond to amounts measured in some currency (e.g., a fiat currency), the dynamically-defined units are non-monetary units, not expressed in the currency, even though a unitary quantity of the dynamically-defined unit may correspond to so many units in some currency (e.g., some many dollars and cents).

Following the operation 1206, an operation 1208 is next.

At the operation 1208, a net outflow from the one or more accounts for the particular category for a portion of a defined period are identified based on the transfers corresponding to the particular category. Notably, such an outflow may be determined in manners similar to the determining of a net outflow discussed above in relation to the operation 406 (FIG. 4) of the method 400, with the difference that the portion of the defined period for which the net outflow is being determined at the operation 1208 serves as the entire defined period as that term is used in the discussion of the operation 406. That said, where the portion of the defined period encompasses the entire period in which transfers have occurred, the two operations may be equivalent. This, for example, may be the case when the balance of the defined period other than the portion happens to fall entirely in the future (e.g., when the portion of the defined period corresponds to the portion of a defined period that has occurred to date).

Following the operation 1208, an operation 1210 is next.

At the operation 1210, the net outflow for the particular category for the portion of the defined period is compared to an expected outflow for the entirety of the defined period for the particular category. In this way a remaining expected outflow for the remainder of the defined period may be determined.

The expected outflow may be determined in a variety of manners. For example, the expected outflow may be determined in manners discussed above in relation to the operation 406 (FIG. 4) of the method 400.

The comparison of the net outflow to the expected outflow may also proceed in a variety of manners. For example, it could be that the remaining expected outflow for the particular category for the remaining portion of the defined period is determined by subtracting the net outflow for the particular category for the portion of the defined period from the expected outflow for the entirety of the defined period for the particular category to yield the remaining expected outflow.

Following determination of the remaining expected outflow for the particular category for the remainder of the defined period at the operation 1210, an operation 1212 is next.

At the operation 1212, an indication expressing the remaining expected outflow for the particular category for the remaining portion of the defined period in at least one of the one or more units defined for the particular category is provided. For example, where a single unit was defined, an indication may be provided expressing the remaining expected outflow in terms of that unit. Such a provision may take a variety of forms. For example, the indication may be sent to another computing device associated with a user (e.g., the mobile computing device 150) for presentation. Additionally, the indication may be queued for later retrieval by and/or sending to such a remote computing device such as for presentation. Notably, where indications are so queued, an expiration time may be associated with the queue and/or each question therein so that indications can be discarded before they become irrelevant. Additionally or alternatively, indications may be tagged with metadata related to the condition they are intended to signal and may be reviewed periodically and/or at dequeue in order to validate they are still relevant before providing them for presentation. In a particular example, the indication may be sent to the mobile computing device 150 by way of the network 140 such as, for example, using the communications module 230.

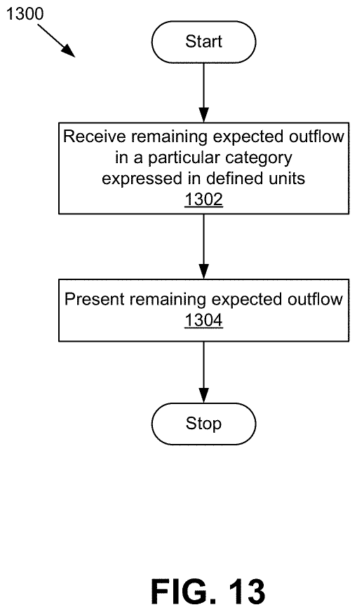

Manners of presenting a status indication expressing a remaining expected outflow for a particular category will now be discussed with reference to FIG. 13.

FIG. 13 provides a flowchart depicting example operations performed in a method 1300 of presenting a status indication expressing a remaining expected outflow for a particular category. Operations starting with an operation 1302 and continuing onward are performed by the processor 610 (FIG. 2) of the mobile computing device 150 executing software comprising instructions such as may be stored in the memory 620 of the mobile computing device 150.

At the operation 1302, remaining expected outflow in a particular category expressed in defined units is received for presentation as a status indication.

An indication expressing the remaining outflow for a particular category drawn from a set of categories may be received. The remaining outflow is a remaining outflow for a remaining portion of a defined period. The remaining outflow is expressed in units defined based on one or more typical amounts of transfers in one or more accounts corresponding to the particular category. The remaining expected outflow may be determined by comparing an expected outflow from the one or more accounts for the particular category for an earlier portion of the defined period to an expected outflow for the entirety of the defined period such as, for example, in manners as discussed above in relation to the method 1200 (FIG. 12).

The indication expressing the remaining outflow may be received from a remote server system such as, for example, the server computer system 100. The indication may be received via a computer network such as, for example, the network 140. The indication may be received using the communications module 640. In a particular example, the indication may be received using the communications module 640 from the server computer system 100 via the network 140.

Notably, the indication received by the mobile computing device 150 at the operation 1302 may correspond to the indication provided by the server computer system 100 at the operation 1212 (FIG. 12) of the method 1200.

Following the receiving at the operation 1302, an operation 1304 is next.

At the operation 1304, the indication received at the operation 1302 is presented.

The indication and information contained therein may be presented in a variety of manners. For example, a graphic may be presented indicating the net outflow for the defined period for the particular category relative to the expected outflow for the defined period for the particular category. Such a graphic indicator may be presented automatically such as, for example, by displaying it at the top of a user interface of an app in various circumstances such as, for example, when the user has indicated they want to track the category periodically. Additionally or alternatively, an option may be providing allowing a user to review net outflow in a particular category on demand (e.g., status indication is displayed on-demand). Notably, in some instances, the status indication may be provided to a user based on a detected condition such as, for example, when the net outflow for a particular category for a period reaches some defined period of the expected outflow for the period (e.g., 25%, 50%, and/or 75%).

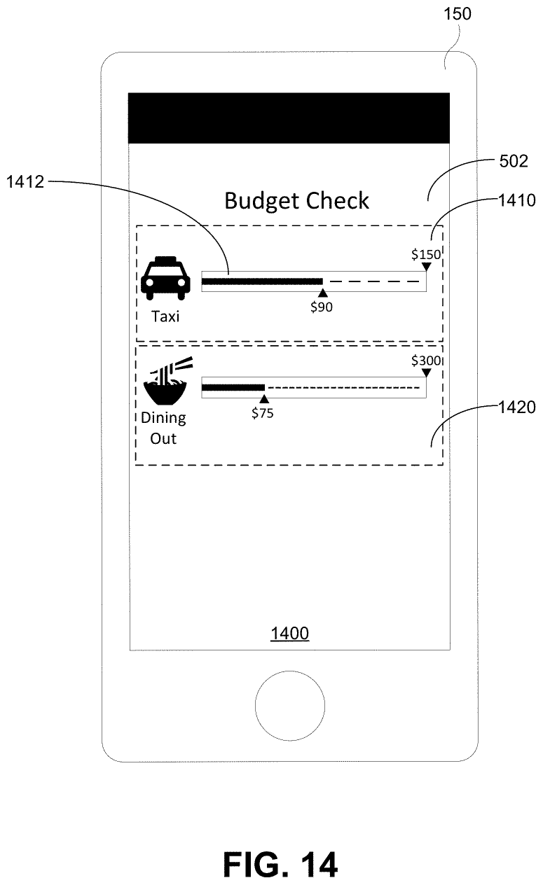

An example user interface for presenting such an indication will now be discussed with reference to FIG. 14.

FIG. 14 shows an example user interface 1400 for use in presenting a status indication related to consumption of quantities in terms of dynamically-defined units.

The example user interface 1400 is depicted as being displayed on the display 502 of the mobile computing device 150.

The example user interface 1400 includes a first area 1410 such as may correspond to a presentation of a first status indication related to consumption in a first category. The example user interface 1400 also includes a second area 1420 such as may correspond to a presentation of a second status indication related to consumption in a second category.

Referring to the first area 1410, an indication 1412 is provided expressing the remaining expected outflow, in this case a remaining budgeted amount, in terms of units defined based on typical amounts of transfers in the first category, in this case taxi spending with the typical amounts of transfers corresponding to taxi rides. As illustrated, a total budget of $150 corresponds to the expected outflow in the taxi category for a period. The net outflow in the period so far is $90. The remaining expected outflow of $60 is expressed in terms of rides, denoted as discrete units on the display. In particular, the indication 1412 shows that 5 rides remain in the budget (suggesting the units used to express the remaining expected outflow is a typical ride of about $12).

The second area 1420 includes similar features including an indication of remaining dining out such as may, for example, correspond to meals.

It is noted that the one or more units used in providing an indication for a particular category may correspond to typical purchases in the particular category such as, for example, taxi or ride-sharing trips, meals such as when eating out, and/or visits such as, for example to a service provider or a store. For example, referring again to the first area 1410, the indication may correspond to typical taxi ride as discussed. In some cases, it may be that purchases in a particular category are initiated using a particular software application. For example, where an indication is provided related to ride-sharing rides, the purchases (rides) may be initiated using a software application such as, for example, a ride-sharing app like Uber or Lyft, it may be that an option is provided to launch such a software application. It could be that user interface is provided allowing a user to provide input to cause such a software application to launch (e.g., by interacting with a portion of the display 502 such as, may for example, be employed in presenting the indication). In a particular example, after presenting an indication at the operation 1304, input related to the presented indication may be received. For example, such input may be received using an input module such as, for example, the I/O module 630. Responsive to the input related to the indication, a software application used to initiate purchases in the particular category may be launched. For example, in the case of an indication related to ride-sharing rides, a ride-sharing app may be launched. Notably, it may be that the particular category corresponds one-to-one with a particular merchant (e.g., purchases made with a particular merchant such as, for example, Uber™ or Amazon.com™). In such a case, launching a software application used to initiate purchases in the particular category may correspond to launching an app supplied by and/or corresponding to that particular merchant.

It will be understood that the applications, modules, routines, processes, threads, or other software components implementing the described method/process may be realized using standard computer programming techniques and languages. The present application is not limited to particular processors, computer languages, computer programming conventions, data structures, or other such implementation details. Those skilled in the art will recognize that the described processes may be implemented as a part of computer-executable code stored in volatile or non-volatile memory, as part of an application-specific integrated chip (ASIC), etc.

As noted, certain adaptations and modifications of the described embodiments can be made. Therefore, the above discussed embodiments are considered to be illustrative and not restrictive.

What is claimed is:

1. A computer system comprising:
a processor;
a communications module coupled to the processor; and
a memory coupled to the processor and storing instructions that, when executed by the processor, cause the computer system to:
receive, using the communications module from one or more remote computing devices via a computer network, records related to a plurality of transfers for one or more accounts, the transfers corresponding to a plurality of categories;
identify, based on the transfers corresponding to a particular category of the plurality of categories, a net outflow from the one or more accounts for a defined period for the particular category;
determine that an amount of the net outflow for the defined period for the particular category exceeds an expected outflow for the defined period for the particular category;
further to determining that the amount of the net outflow for the defined period for the particular category exceeds the expected outflow for the defined period for the particular category, generate a multiple-choice quiz question and a corresponding set of possible responses including a correct response corresponding to the particular category and one or more distractor responses not corresponding to the particular category; and
provide the multiple-choice quiz question and the corresponding set of possible responses for presentation in association with the one or more accounts.

2. The computer system of claim 1, wherein the multiple-choice quiz question is based on the net outflow for the defined period for the particular category.

3. The computer system of claim 1, wherein each response of the set of possible responses corresponds to a respective category of the plurality of categories.

4. The computer system of claim 1, wherein the particular category is one of a set of tracked categories.

5. The computer system of claim 1, wherein generating the corresponding set of possible responses includes validating the one or more distractor responses to confirm they do not correspond to the particular category.

6. The computer system of claim 1, wherein generating the multiple-choice quiz question includes:
selecting a multiple-choice quiz question template from amongst a plurality of multiple-choice quiz question templates; and
populating the selected multiple-choice quiz question template based on at least the particular category to yield the multiple-choice quiz question.

7. The computer system of claim 1,
wherein categories of the plurality of categories correspond to a plurality of merchant classes,
wherein one or more of the records indicate merchant classes associated with transfers related to those records, and
wherein identifying, based on the transfers corresponding to the particular category of the plurality of categories, the net outflow from the one or more accounts for the defined period for the particular category includes identifying records indicating merchant classes corresponding to the particular category.

8. The computer system of claim 1,
wherein categories of the plurality of categories correspond to a plurality of merchants,
wherein one or more of the records indicate merchants associated with transfers related to those records, and
wherein identifying, based on the transfers corresponding to the particular category of the plurality of categories, the net outflow from the one or more accounts for the defined period for the particular category includes identifying records indicating merchants corresponding to the particular category.

9. The computer system of claim 1, wherein the instructions, when executed by the processor further cause the computer system to:
determine the expected outflow for the defined period for the particular category based on at least one of a net outflow for the particular category for an earlier period and information related to transfers in the particular category for one or more other accounts, the other accounts not associated with an owner of the one or more accounts.

10. The computer system of claim 1, wherein the instructions, when executed by the processor further cause the computer system to:
prior to determining that the net outflow from the one or more accounts for the defined period for the particular category exceeds the expected outflow for the defined period for the particular category, receive an indication of user-input defining the expected outflow for the defined period for the particular category.

11. A computer-implemented method comprising:
receiving, from one or more remote computing devices via a computer network, records related to a plurality of transfers for one or more accounts, the transfers corresponding to a plurality of categories;
identifying, based on the transfers corresponding to a particular category of the plurality of categories, a net outflow from the one or more accounts for a defined period for the particular category;
determining that an amount of the net outflow for the defined period for the particular category exceeds an expected outflow for the defined period for the particular category;
further to determining that the amount of the net outflow for the defined period for the particular category exceeds the expected outflow for the defined period for the particular category, generating a multiple-choice quiz question and a corresponding set of possible responses including a correct response corresponding to the particular category and one or more distractor responses not corresponding to the particular category; and
providing the multiple-choice quiz question and the corresponding set of possible responses for presentation in association with the one or more accounts.

12. The method of claim 11, wherein the multiple-choice quiz question is based on the net outflow for the defined period for the particular category.

13. The method of claim 11, wherein each response of the set of possible responses corresponds to a respective category of the plurality of categories.

14. The method of claim 11, wherein generating the corresponding set of possible responses includes validating the one or more distractor responses to confirm they do not correspond to the particular category.

15. The method of claim 11, further comprising determining the expected outflow for the defined period for the particular category based on at least one of a net outflow for the particular category for an earlier period and information related to transfers in the particular category for one or more other accounts, the other accounts not associated with an owner of the one or more accounts.

16. The method of claim 11, further comprising:
prior to determining that the net outflow from the one or more accounts for the defined period for the particular category exceeds the expected outflow for the defined period for the particular category, receiving an indication of user-input defining the expected outflow for the defined period for the particular category.

17. A computer system comprising:
a processor;
a communications module coupled to the processor;
an input module coupled to the processor;
an output module coupled to the processor; and
a memory coupled to the processor and storing instructions that, when executed by the processor, cause the computer system to:
receive, using the communications module from a remote server system via a computer network, a multiple-choice quiz question and a corresponding set of possible responses including a correct response corresponding to a particular category of a plurality of categories and one or more distractor responses not corresponding to the particular category, the particular category associated with a net outflow from one or more accounts for a defined period that exceeds an expected outflow for the defined period for the particular category;
present, using the output module, the multiple-choice quiz question and the set of possible responses;
receive, using the input module, input selecting a response from the set of possible responses; and
further to receiving the input, provide an indication based on the selected response.

18. The computer system of claim 17, wherein the indication indicates at least one of the particular category and the amount of the net outflow for the defined period for the particular category.

19. The computer system of claim 17, wherein the multiple-choice quiz question is presented during loading of an application by the computer system.

20. The computer system of claim 17, wherein providing the indication based on the selected response includes:
determining that the received input selected the correct response; and
responsive to determining that the received input selected the correct response, awarding at least one of one or more points and one or more badges.
